(19) United States
(12) Patent Application Publication
(10) Pub. No.: US 2024/0248213 A1
(43) Pub. Date: Jul. 25, 2024

(54) ON-BOARD DEVICE AND POSITIONING METHOD OF ON-BOARD DEVICE

(71) Applicant: Panasonic Automotive Systems Co., Ltd., Kanagawa (JP)

(72) Inventors: Kiyotaka TANIMOTO, Kanagawa Ken (JP); Fumio KOSUGE, Kanagawa Ken (JP); Toshihiko MORI, Kanagawa Ken (JP); Tomoaki ABE, Kanagawa Ken (JP)

(73) Assignee: Panasonic Automotive Systems Co., Ltd., Kanagawa (JP)

(21) Appl. No.: 18/607,115

(22) Filed: Mar. 15, 2024

Related U.S. Application Data
(63) Continuation of application No. PCT/JP2022/036321, filed on Sep. 28, 2022.

(30) Foreign Application Priority Data
Oct. 29, 2021 (JP) 2021-178219

(51) Int. Cl. G01S 19/25

(52) U.S. Cl. CPC G01S 19/252; G01S 19/256

(57) ABSTRACT

A GNSS receiver is capable of receiving GNSS data in an on-board device. The on-board device includes a memory, and a hardware processor coupled to the memory. The hardware processor is configured to: request and acquire time information recorded in the GNSS receiver when the GNSS receiver starts positioning processing; and execute positioning using, as initial positioning data of the GNSS receiver, time information held by the on-board device without acquisition from outside the on-board device, instead of the time information of an initial value recorded in the GNSS receiver, when the time information acquired from the GNSS receiver is in a state of the initial value.

### CROSS-REFERENCE TO RELATED APPLICATIONS

This application is a continuation of International Application No. PCT/JP2022/036321, filed on Sep. 28, 2022 which claims the benefit of priority of the prior Japanese Patent Application No. 2021-178219, filed on Oct. 29, 2021, the entire contents of which are incorporated herein by reference.

### FIELD

The present disclosure relates to an on-board device and a positioning method of the on-board device.

### BACKGROUND

Conventionally, on-board devices equipped with a global navigation satellite system (GNSS) such as GPS have been known.

For vehicles equipped with such on-board devices, services such as operation management and vehicle management using GNSS satellite data are provided.

To receive the provision of such services, it is necessary to transmit data from the vehicle side, which incurs communication charges each time.

In this regard, in recent years, on-board devices that are compatible with ETC 2.0 have been known.

Such an on-board device communicates with a server in normal processing.

This makes it possible to receive the above-mentioned provision of services by using a communication network via a roadside device between the server and the on-board device.

A related technique is described in Japanese Patent No. 4593101.

However, to receive the provision of accurate services, it is necessary to provide GNSS data with no dropouts from the on-board device side to the server side. If there are dropouts in the GNSS data, there is a possibility of not being able to receive accurate services.

While there are various possible reasons for dropouts in GNSS data, one cause on the on-board device side in the on-board device compatible with ETC 2.0 is the inability to immediately receive positioning data because the full-time power supply line is not connected to the on-board device, the almanac data, ephemeris data, and the like necessary for measuring GNSS data (GNSS positioning data) are ineffective immediately after the accessory power supply (hereinafter referred to as ACC) is turned on.

Even in such a case, if the on-board device is connected via an ACC key, although it takes time to acquire accurate GNSS data, the on-board device can execute correct operations after the accurate GNSS data is acquired. However, there is a possibility that it will take time to shift to normal operations.

The problem to be solved by the present disclosure is, even in a state where there is a large discrepancy between the satellite positioning location when power is turned on (for example, when ACC is turned on) and the satellite location stored in the on-board device when the latest location is positioned, to provide an on-board device and a positioning method of the on-board device that can reduce positioning time when ACC is turned on, shift to normal operations in an early stage, and normally receive services provided by external servers and the like in the on-board device.

### SUMMARY

A GNSS receiver is capable of receiving GNSS data in an on-board device according to the present disclosure. The on-board device includes a memory, and a hardware processor coupled to the memory. The hardware processor is configured to: request and acquire time information recorded in the GNSS receiver when the GNSS receiver starts positioning processing; and execute positioning using, as initial positioning data of the GNSS receiver, time information held by the on-board device without acquisition from outside the on-board device, instead of the time information of an initial value recorded in the GNSS receiver, when the time information acquired from the GNSS receiver is in a state of the initial value.

### BRIEF DESCRIPTION OF THE DRAWINGS

FIG. 1 is a schematic configuration block diagram of an on-board device according to an embodiment;

FIG. 2 is a schematic configuration block diagram of a system controller;

FIG. 3 is a functional block diagram illustrating functions of a control processing unit; and

FIG. 4 is an explanatory diagram of a process flowchart of the embodiment.

### DETAILED DESCRIPTION

An embodiments of the present invention will be described below with reference to the drawings.

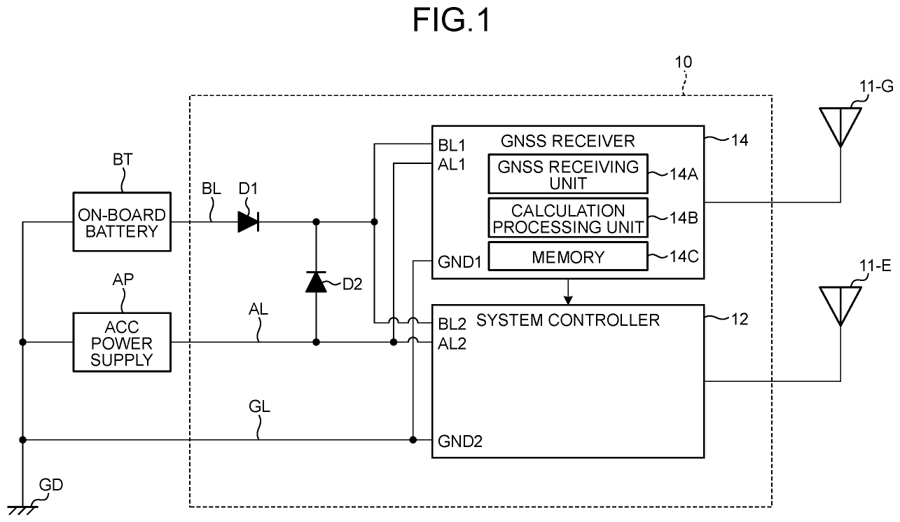

FIG. 1 is a schematic configuration block diagram of an on-board device according to the embodiment.

The on-board device 10 includes a communication antenna 11-E that can communicate with roadside devices and the like that constitute the ETC 2.0 system, a GNSS antenna 11-G that can receive GNSS radio waves from GNSS satellites, a system controller 12 that controls the entire on-board device 10, and a GNSS receiver 14 that executes reception processing on the GNSS radio waves received via the GNSS antenna 11-G to generate and output GNSS data.

Furthermore, the on-board device 10 includes a reverse current prevention diode Dl whose anode terminal is connected to an on-board battery BT and cathode terminal is connected to a full-time power terminal BL1 of the GNSS receiver 14 and a full-time power terminal BL2 of the system controller 12, and a reverse current prevention diode D2 whose anode terminal is connected to an ACC power supply AP and cathode terminal is connected to the full-time power terminal BL1 of the GNSS receiver 14 and the full-time power terminal BL2 of the system controller 12.

With the above configuration, when installing the on-board device 10, even if the on-board device 10 is installed without being connected to the full-time power supply, if the ACC power supply is connected, power can be supplied without reverse current or the like, and the operation is possible.

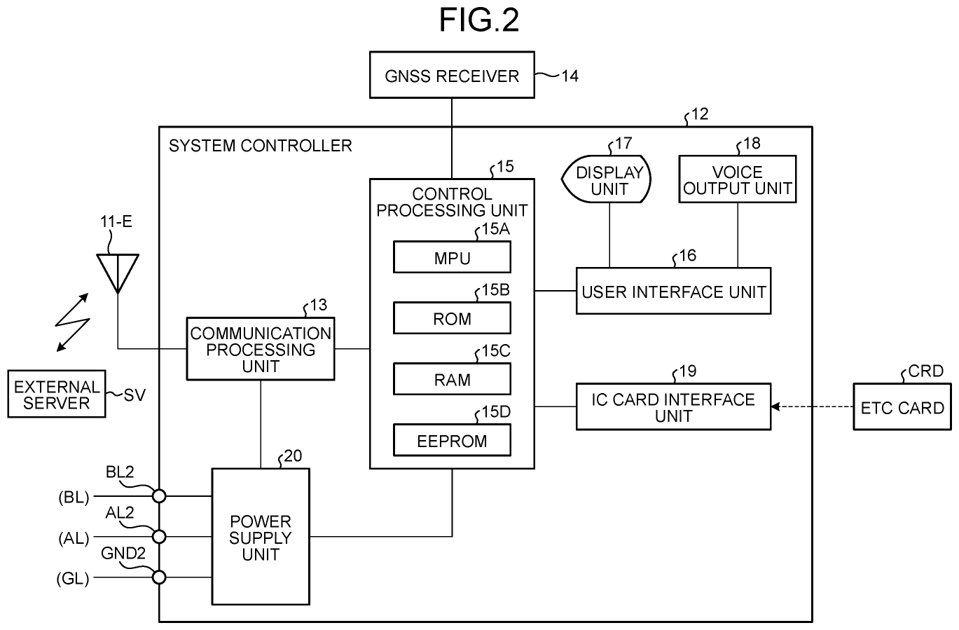

FIG. 2 is a schematic configuration block diagram of the system controller.

As illustrated in FIG. 2, the system controller 12 includes a communication processing unit 13 that executes communication processing with the ETC 2.0 system (for example, external server SV) via the communication antenna 11-E, a control processing unit 15 that controls the entire on-board device 10 and processes various data, a user interface unit 16 that executes user interface processing, a display unit 17 that displays various pieces of information under the control of the user interface unit 16, a voice output unit 18 that outputs various pieces of information as voice information under the control of the user interface unit 16, an IC card interface unit 19 that executes interface processing with an ETC card CRD, and a power supply unit 20 that is connectable to a full-time power supply line BL from the on-board battery BT via the full-time power terminal BL2, connectable to an ACC power supply line AL from the ACC power supply AP via an ACC power supply lower terminal AL2, connectable to a ground line GL from a ground GD via a ground terminal GND2, and supplies operating power to each unit of the on-board device 10.

In the above configuration, as illustrated in FIG. 1, the GNSS receiver 14 includes a GNSS receiving unit 14A that processes received signals received from GNSS satellites to generate and output received data (positioning data, time data, and the like), a calculation processing unit 14B that executes various calculation processes based on the received data output by the GNSS receiving unit 14A and outputs calculation results to the system controller 12, and a memory 14C that functions as a storage unit including a volatile storage unit such as a RAM and a non-volatile storage unit such as an EEPROM to temporarily expand and process various data.

Here, location information and time information obtained by the latest positioning processing are stored in the memory 14C in an updatable manner.

The ephemeris data is orbital data that indicates the accurate satellite location used for location calculations, and is unique data used only by the satellite with the satellite number that transmits the ephemeris data.

The effective period of this ephemeris data is, for example, approximately four hours for GPS. That is, after the effective period has elapsed since the acquisition, the ephemeris data becomes ineffective and cannot be used for processing.

The almanac data is a simplified version of the ephemeris data, and includes simplified orbit data of all satellites currently in operation, including the satellite that transmits the almanac data.

The effective period of this almanac data is, for example, approximately six days for GPS. That is, after the effective period has elapsed since the acquisition, the almanac data becomes ineffective and cannot be used for processing.

The almanac data is used to find satellites available for the GNSS receiving unit 14A of the GNSS receiver 14 to determine the current location and time.

The control processing unit 15 includes an MPU 15A that controls the entire control processing unit 15, a ROM 15B that stores various data such as programs in a non-volatile manner, a RAM 15C that expands processing programs and temporarily stores processing data, and an EEPROM 15D that stores various data including the positioning history data, which will be described later, in a non-volatile and rewritable manner.

The power supply unit 20 and the on-board battery BT can be connected via the full-time power supply line BL, and the power supply unit 20 and the ACC power supply AP can be connected via the ACC power supply line AL. The power supply unit 20 and the ground GD can be connected via the ground line GL.

In the actual device configuration, fuses as a safety device are installed on the full-time power supply line BL and the ACC power supply line AL. Even if the full-time power supply line BL of the on-board device 10 is connected to the ACC power supply line AL, the on-board device 10 can operate.

In the present embodiment, every time the GNSS receiving unit 14A of the GNSS receiver 14 acquires the positioning data including the positioning time, the location information on the positioning location, and the azimuth information and a predetermined condition is satisfied, the control processing unit 15 stores the positioning data in the EEPROM 15D in a non-volatile manner.

More specifically, the control processing unit 15 processes each acquired data and records the location information having a predetermined distance or more (for example, for each 200 m) in the EEPROM 15D. In addition, the control processing unit 15 records the location information in the EEPROM 15D when the traveling direction of the vehicle changes by a predetermined angle or more (for example, 45 degrees or more) based on the azimuth information. Since the location information is associated with the time information on the positioning time, this data becomes the positioning history data.

In this case, the predetermined condition means that a predetermined time has elapsed since the previous storage timing of positioning data, that positioning has been executed a predetermined number of times after the previous storage timing of positioning data, and the like.

Here, the functional configuration of the control processing unit 15 will be described.

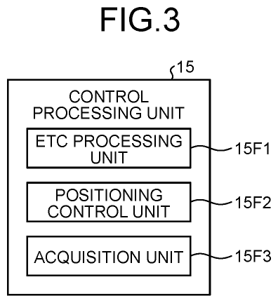

FIG. 3 is a functional block diagram illustrating functions of the control processing unit.

The control processing unit 15 includes an ETC processing unit 15F1, a positioning control unit 15F2, and an acquisition unit 15F3.

These functions are implemented by the MPU 15A executing programs stored in the ROM 15B. Note that the form in which, for example, at least some of these functions are implemented by a dedicated hardware circuit may be employed.

The ETC processing unit 15F1 communicates with the ETC 2.0 system such as the external server SV via the communication processing unit 13 and the communication antenna 11-E, providing vehicle information to the ETC 2.0 system side. As a result, a servicer of the ETC 2.0 system accumulates and processes data to provide various pieces of information from ETC 2.0 vehicle information collected by the external server SV and the like, provides highway information, acquires various pieces of information such as detailed road information in the traveling direction based on the location of the vehicle equipped with the on-board device 10, and provides various services via the ETC processing unit 15F1.

When the time information acquired from the GNSS receiver 14 is in the state of initial value, the positioning control unit 15F2 executes positioning by using the time information held by the on-board device 10 without acquisition from outside the on-board device 10 as initial positioning data of the GNSS receiver 14, instead of the time information on the initial value recorded in the GNSS receiver 14.

In this case, the time information “held by the on-board device 10 without acquisition from outside the on-board device 10” means the time information calculated by the on-board device 10 itself and held in advance in the EEPROM 15D and the like in a non-volatile manner in the present embodiment.

In the present embodiment, only the time information is replaced because, as in Japan, there is not much difference in the placement of GNSS satellites that can be used for positioning at any place, and the time information has a greater influence on the positioning processing than the location information.

When the GNSS receiver 14 starts the positioning processing, the acquisition unit 15F3 requests and acquires the time information recorded in the GNSS receiver 14.

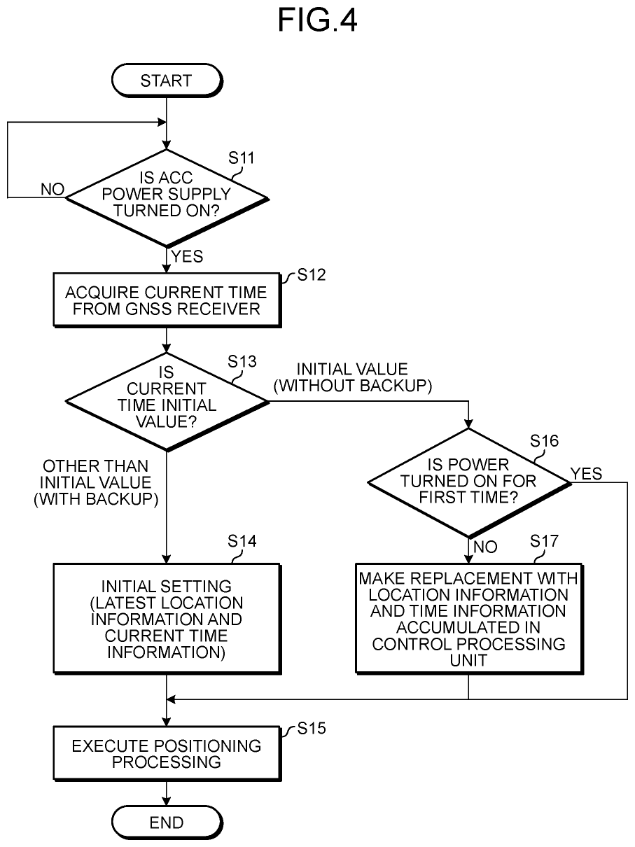

FIG. 4 is an explanatory diagram of a process flowchart of the embodiment.

First, the control processing unit 15 determines whether the ACC power supply AP is turned on and power is supplied from the ACC power supply AP via the power supply unit 20 (step S11).

In the determination at step S11, when power is not supplied from the ACC power supply AP (step S11; No), a standby state starts.

In the determination at step S11, when power is supplied from the ACC power supply AP (step S11; Yes), the control processing unit 15 (acquisition unit 15F3) requests the GNSS receiver 14 to output the latest positioning data. As a result, the control processing unit 15 acquires the positioning data output from the GNSS receiver 14 in response to the request.

Therefore, the control processing unit 15 (acquisition unit 15F3) acquires the location information held by the GNSS receiver 14 (step S12).

In this case, when the full-time power supply line BL is connected, that is, when the backup power supply is connected, the GNSS receiver 14 holds the location information and the time information included in the positioning data when the previous GNSS data is received. In contrast, when the backup power supply is not connected, since there are no location information and time information included in the positioning data when the previous GNSS data is received, the GNSS receiver 14 outputs the initial value (default value) read from a predetermined non-volatile memory (for example, ROM) that constitutes the memory 14C as the location information and the current time.

Therefore, the control processing unit 15 determines whether the current time (time information) acquired from the GNSS receiver 14 is the predetermined initial value (step S13).

Note that as the case where data corresponding to the current time is the predetermined initial value, as described above, in addition to the case where power backup is not performed, there can also be a case where the power has not been turned on for a predetermined period of time.

In the determination at step S13, when the current time acquired by the control processing unit 15 (acquisition unit 15F3) from the GNSS receiver 14 is other than the initial value (with backup) (step S13; other than the initial value), the control processing unit 15 (positioning control unit 15F2) instructs the GNSS receiver 14 to make an initial setting with the latest location information and current time stored by the GNSS receiver 14 as the initial value for positioning (step S14).

Subsequently, the calculation processing unit 14B of the GNSS receiver 14 receives radio waves from GNSS satellites by using the initialized latest location information and current time, executes the positioning processing (step S15), and calculates the new current location and current time to outputs the calculated data to the control processing unit 15 of the system controller 12.

Then, the control processing unit 15 stores new positioning history data.

In the determination at step S13, when the read current time is the predetermined initial value (without backup) (step S13; initial value), the control processing unit 15 of the system controller 12 determines whether the power is turned on in step S11 for the first time after the on-board device 10 is installed (step S16).

This is because the fact that the power is turned on for the first time after the on-board device 10 is installed represents that positioning has not yet been executed in the on-board device 10 and the positioning history data (backup data) itself does not exist

In the determination at step S16, when the power is not turned on for the first time after the on-board device 10 is installed (step S16; No), when the time information acquired from the GNSS receiver 14 is in the state of initial value, the control processing unit 15 (positioning control unit 15F2) operates to execute positioning by using the time information held by the on-board device 10 without acquisition from outside the on-board device 10 as the initial positioning data of the GNSS receiver 14, instead of the time information having the initial value recorded in the GNSS receiver 14.

That is, the control processing unit 15 (positioning control unit 15F2) instructs the GNSS receiver 14 to acquire the location information and time information that are the latest accumulation data from the positioning history data that has already been acquired by the control processing unit 15 and stored in the EEPROM 15D, and replace the initial value of the GNSS receiver 14 (initial location information and initial time information) (step S17).

As a result, the calculation processing unit 14B of the GNSS receiver 14 receives data from GNSS satellites by using the latest location information and time information in the positioning history data acquired from the system controller 12, executes the positioning processing (step S15), and calculates the new current location and current time to output the calculated data to the control processing unit 15 of the system controller 12.

Then, the control processing unit 15 stores new positioning history data.

In the determination at step S16, when the power is turned on for the first time after the on-board device 10 is installed (step S16; Yes), since the positioning history data is not stored in the system controller 12, the control processing unit 15 (positioning control unit 15F2) controls the GNSS receiver 14 to receive radio waves from GNSS satellites and executes positioning processing by using the location information and time information having the initial value (step S15).

As a result, the calculation processing unit 14B of the GNSS receiver 14 executes positioning processing by using the predetermined initial value of location information and the predetermined initial value of time information, calculates the new current location and current time, and outputs the calculated data to the control processing unit 15 of the system controller 12.

Then, the control processing unit 15 stores new positioning history data.

As described above, according to the present embodiment, even if the time information is not backed up in the GNSS receiver 14, due to reasons such as the on-board device 10 not being connected to the full-time power supply, when the power is turned on (for example, when the ACC power supply is turned on), the control processing unit 15 replaces the time information (and location information) corresponding to the latest positioning time stored in a non-volatile manner as time information (and location information) used in the GNSS receiver 14 by the control processing unit 15 functioning as the positioning control unit 15F2. As a result, compared to the case where positioning is executed by using the predetermined initial value in the GNSS receiver, positioning can be executed in a shorter time, and furthermore, it is possible to quickly start providing services related to the vehicle location quickly provided by the external server SV.

Each of the embodiments of the present disclosure have been described above, but the present disclosure is not limited to each of the embodiments described above, and various changes can be made without departing from the spirit of the present invention.

For example, in the above description, the control processing unit 15 stores the positioning history data, and when the time information acquired from the GNSS receiver is in the state of initial value, instead of the time information of the initial value, the control processing unit 15 executes positioning by using the latest positioning data out of the positioning history data (location information and time information) as the initial positioning data of the GNSS receiver 14.

However, when the control processing unit 15 stores only the latest positioning data (or time information corresponding to the latest positioning data) as the time information held by the on-board device without acquisition from outside the on-board device, and when the time information acquired from the GNSS receiver 14 is in the state of initial value, instead of the time information of the initial value, it is possible to executes positioning by using the latest positioning data as the initial positioning data of the GNSS receiver 14 (initial time information).

In the above description, the positioning history data is updated every time the positioning data is output from the GNSS receiver 14. However, it is also possible to configure the ETC 2.0 system such that every time probe data is transmitted to a roadside device, positioning data corresponding to the probe data is updated as the positioning history data.

According to the present disclosure, even in a state where there is a large discrepancy between the satellite positioning location when power is turned on (for example, when ACC is on) and the satellite location stored in the on-board device when the latest location is positioned, it is possible to reduce the positioning time when power is turned on and shift to normal operations in an early stage.

Furthermore, it is possible to normally receive the provision of services using the positioning data by external service servers and the like.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An on-board device in which a GNSS receiver is capable of receiving GNSS data, the on-board device comprising:
a memory; and
a hardware processor coupled to the memory,
the hardware processor being configured to:
request and acquire time information recorded in the GNSS receiver when the GNSS receiver starts positioning processing; and
execute positioning using, as initial positioning data of the GNSS receiver, time information held by the on-board device without acquisition from outside the on-board device, instead of the time information of an initial value recorded in the GNSS receiver, when the time information acquired from the GNSS receiver is in a state of the initial value.

2. The on-board device according to claim 1, wherein
the memory is configured to hold positioning history data including a portion of positioning data corresponding to the GNSS data previously received by the GNSS receiver, and
the hardware processor is configured to execute positioning using, as the initial positioning data of the GNSS receiver, time information in latest positioning data out of the positioning data held as the positioning history data, instead of the time information of the initial value recorded in the GNSS receiver, when the time information acquired from the GNSS receiver is in the state of the initial value.

3. The on-board device according to claim 2, wherein the positioning history data includes location information for each predetermined distance and location information for each time a traveling direction changes by a predetermined angle or more, and is recorded in association with the time information on a time of positioning of each piece of the location information.

4. The on-board device according to claim 1, wherein the on-board device is an electronic toll collection system (ETC) on-board device.

5. A positioning method of an on-board device in which a GNSS receiver is capable of receiving GNSS data,
the on-board device including a recording unit that holds positioning history data including a portion of positioning data corresponding to the GNSS data previously received by the GNSS receiver,
the positioning method comprising:
requesting and acquiring time information recorded in the GNSS receiver when the GNSS receiver starts positioning processing; and
executing positioning using, as initial positioning data of the GNSS receiver, time information held by the on-board device without acquisition from outside the on-board device, instead of the time information of the initial value recorded in the GNSS receiver, when the time information acquired from the GNSS receiver is in a state of an initial value.

6. The positioning method according to claim 5, wherein the positioning history data includes location information for each predetermined distance and location information for each time a traveling direction changes by a predetermined angle or more, and is recorded in association with the time information on a time of positioning of each piece of the location information.
